(19) United States
(12) Patent Application Publication
(10) Pub. No.: US 2004/0105247 A1
(43) Pub. Date: Jun. 3, 2004

(54) Diffusing backlight assembly

(76) Inventors: Nate Howard Calvin, (US); Dean Wilkinson, (US)

Correspondence Address: FULBRIGHT & JAWORSKI, LLP, 1301 MCKINNEY, SUITE 5100, HOUSTON, TX, 77010-3095, US

(21) Appl. No.: 10/308,758

(22) Filed: Dec. 3, 2002

(51) Int. Cl. F21V 7/04

(52) U.S. Cl. 362/31; 362/26; 362/27; 362/555; 362/561

(57) ABSTRACT

A backlight assembly for a liquid crystal display that may include multiple light guides, reflector materials, and light sources of multiple wavelengths, and that may blend light colors to create a balanced illuminating instrument light of uniform brightness.

### BACKGROUND OF THE INVENTION

Gauges and other instruments, including liquid crystal displays (“LCDs”), used in a variety of equipment, such as automobiles and aircraft, have long been illuminated to facilitate viewing in dark conditions, such as at night. Active matrix LCDs typically require rear illumination for viewing under any ambient lighting condition. Such illumination has often been effected using backlight assemblies that include light sources, such as light emitting diodes (“LEDs”) and light guides, which are diffusing optical elements comprising suitable light diffusing material such as glass, acrylic, or other plastic. In order to avoid the brightness of direct light from the light sources, the light sources have been arranged along the edge of the light guide and hidden from the viewer of the instrument. The light from the light source is scattered across the face of the instrument via the light guide. Disadvantages of such assemblies include a lack of homogeneity in the backlighting intensity and an inability to satisfactorily and homogeneously mix light from light sources of different wavelengths.

### SUMMARY OF THE INVENTION

There is provided herein a backlight assembly comprising a light, a light guide having a perimeter, and a reflector positioned between the light and the light guide. The foregoing backlight assembly may further comprise a second light guide, and the reflector positioned between the first light guide and the second light guide. The light may be a LED light. The light may comprise light sources emitting different wavelengths. The reflector may be positioned to intersect a centerline, perpendicular to the reflector, of the light guide. The reflector may also be positioned to define a gap between the reflector and the perimeter of the light guide. The reflector may also be positioned so that radiation from the light emits into the light guide at opposite ends of the reflector.

### BRIEF DESCRIPTION OF THE DRAWINGS

FIG. 1 is a top view of an exemplary backlight assembly in accordance with the present invention.

FIG. 2 is a cross-sectional side view of the backlight assembly of FIG. 1.

### DESCRIPTION OF THE PREFERRED EMBODIMENTS

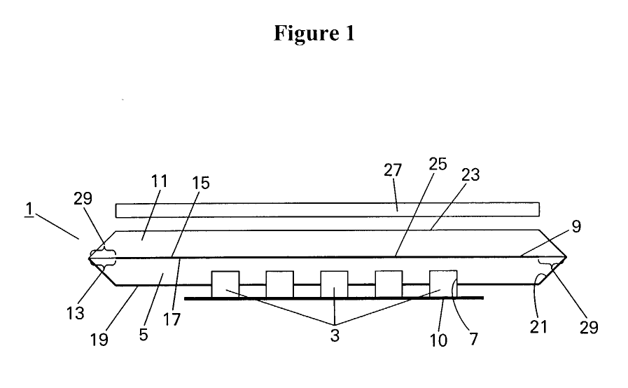

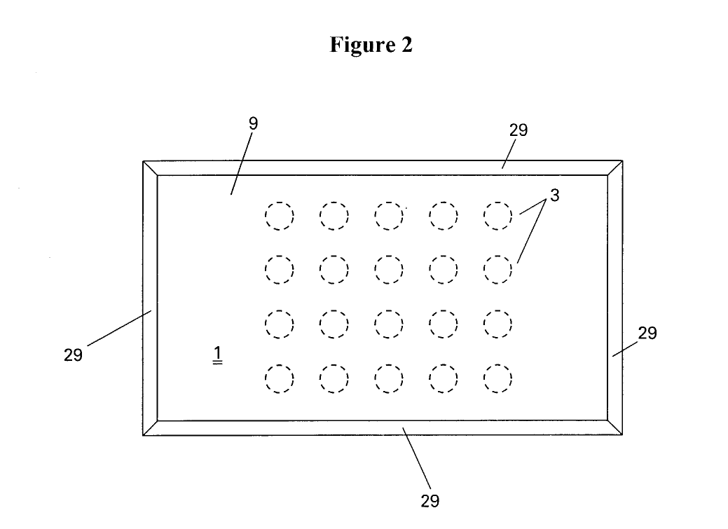

FIG. 2 is a top view of an exemplary backlight assembly 1 in accordance with the present invention, exhibiting in shadow the position of LEDs 3. FIG. 1 is a cross-sectional side view of the backlight assembly 1 of FIG. 2.

Referring to the drawings, the backlight assembly 1 comprises a rear light guide 5 and front light guide 11, both made of optically clear acrylic. The rear light guide 5 exhibits cavities 7 in which LEDs 3 are embedded. The LEDs 3 may be bonded into the cavities 7 with an optical adhesive that matches the index of refraction of the rear light guide 5. The LEDs are mounted to a circuit board 10.

A reflector stack 9 is sandwiched between rear light guide 5 and front light guide 11. Either or both of light guides 5 and 11 may be machined or molded to receive reflector stack 9, such that the perimeter portions 13 of the light guides 5 and 11 are adjacent. Light guides 5 and 11 may be bonded along their perimeter portions 13 using an optical adhesive that matches the index of retraction of both light guides, or they may be clamped. Alternatively, light guides 5 and 11 may be a single unit molded around the reflector stack 9.

The reflector stack 9 comprises an opaque, or reflective, material, such as aluminum, and is coated with Lambertian, or light diffusing, material, such as white paint. The opaque material prevents light from passing through the reflector stack 9, while the Lambertian material on the upper surface 15 and lower surface 17 of the reflector stack 9 reflects and scatters incident light. The reflector stack 9 so comprised is both highly reflective and diffusing. Additional reflectors that are both highly reflective and diffusing are located at the rear 19 of rear light guide 5, and along the angled sides 21 of rear light guide 5.

Front light guide 11 has a front surface 23 and a rear surface 25 that are textured with small optical elements, such as angled grooves, the purpose of which is to cause light traveling within the front light guide 11 to escape toward an LCD 27. The exact texturing may be determined by one of ordinary skill, chosen as a function of the wavelength of the LEDs 3 and of Brewster's angle associated with the light guide material, and chosen to render a uniform light pattern and to minimize Morie patterning, or “beating.”

The backlight assembly 1 so comprised exhibits a light gap, or slit, 29 along the perimeters 13. Light emitted from the LEDs 3 is reflected and diffused between the lower surface 17 of reflector stack 9, the rear 19 of rear light guide 5, and the angled sides 21 of rear light guide 5, escaping only along the light slit 29. From light slit 29 the light enters front light guide 11, where the light is further diffused and from which LCD 27 is illuminated. A diffuser and brightness enhancing films, such as reflective polarizer film or directional film, may be placed between the front light guide 11 and the LCD 27 to enhance the uniformity and brightness of the light that passes through the LCD 27.

With the benefit of this disclosure, one of ordinary skill will recognize that several embodiments of the invention are possible within the scope of the claims. Because of the light homogenizing effect of the invention, light from LEDs of different wavelengths may be mixed to create precisely desired effects. As used in the claims, “light” may be a single light or an array of light sources.

I claim:

1. A backlight assembly comprising:
a light;
a light guide having a perimeter; and
a reflector positioned between the light and the light guide.

2. The apparatus of claim 1 further comprising a second light guide, the reflector positioned between the first light guide and the second light guide.

3. The apparatus of claim 1 in which the light is a LED light.

4. The apparatus of claim 1 in which the light comprises light sources emitting different wavelengths.

5. The apparatus of claim 1 in which the reflector is positioned to intersect a centerline, perpendicular to the reflector, of the light guide.

6. The apparatus of claim 2 in which the reflector is positioned to define a gap between the reflector and the perimeter of the light guide.

7. The apparatus of claim 5 in which the light is positioned to intersect a centerline, perpendicular to the reflector, of the light guide.

8. The apparatus of claim 5 in which the light comprises light sources emitting different wavelengths.

9. The apparatus of claim 6 in which the light is positioned to define a gap between the reflector and the perimeter of the light guide.

10. The apparatus of claim 6 in which the light comprises light sources emitting different wavelengths.

11. The apparatus of claim 7 in which the light comprises light sources emitting different wavelengths.

12. The apparatus of claim 1 in which the reflector is positioned so that radiation from the light emits into the light guide at opposite ends of the reflector.
